(19) United States
(12) Patent Application Publication
(10) Pub. No.: US 2026/0163200 A1
(43) Pub. Date: Jun. 11, 2026

(54) BATTERY MODULE AND BATTERY PACK

(71) Applicant: SAMSUNG SDI CO., LTD., Yongin-si (KR)

(72) Inventors: Joong Woo NAM, Suwon-si (KR); Suk Kyum KIM, Suwon-si (KR)

(21) Appl. No.: 19/180,615

(22) Filed: Apr. 16, 2025

(30) Foreign Application Priority Data
Apr. 17, 2024 (KR) 10-2024-0051525

(51) Int. Cl. H01M 50/522; B60L 3/00; B60L 3/04; H01M 50/209; H01M 50/249; H01M 50/503; H01M 50/514; H01M 50/574

(52) U.S. Cl. CPC H01M 50/522; B60L 3/0046; B60L 3/04; H01M 50/209; H01M 50/249; H01M 50/503; H01M 50/514; H01M 50/574; H01M 2220/20

(57) ABSTRACT

A battery module and a battery pack are disclosed. A battery module includes a plurality of battery cells each including a terminal on at least one side, a bus bar configured to electrically connect at least some of the plurality of battery cells, and a coupling portion configured to couple the terminal and the bus bar through a magnetic force.

### CROSS-REFERENCE TO RELATED APPLICATION

This application claims priority to and the benefit of Korean Patent Application No. 10-2024-0051525, filed on Apr. 17, 2024 in the Korean Intellectual Property Office, the entire disclosure of which is incorporated herein by reference.

### BACKGROUND

### 1. Field

Aspects of embodiments of the present disclosure relate to a battery module and a battery pack.

### 2. Description of the Related Art

Unlike a primary battery that cannot be recharged, a secondary battery is a battery that can be charged and discharged. A low-capacity battery may be used for portable small-sized electronic devices, such as smartphones, feature phones, notebook computers, digital cameras, and camcorders, and a high-capacity battery is widely used as a power source for driving a motor and a power storage battery in hybrid vehicles, electric vehicles, or the like, for example. Such a battery includes electrodes including a positive electrode and/or a negative electrode, an electrode assembly including the electrodes, a case that accommodates the electrode assembly, electrode terminals connected to the electrode assembly, and the like.

As technology advances, batteries with high capacity are required. Accordingly, a plurality of batteries may be electrically connected and used. For example, the battery may be applied to an electronic device in the form of a battery module including a plurality of batteries, and/or a battery pack including a plurality of battery modules. In this case, the electronic device may be an electronic device that requires high power and/or high capacity and may include, for example, an electric vehicle or the like.

The battery module includes a plurality of battery cells. At least some of the plurality of battery cells are connected by a bus bar. For example, the bus bar may be located at an upper end of the plurality of battery cells and electrically connects the plurality of battery cells.

Each of the battery cells includes an electrode assembly and a case that accommodates the electrode assembly. The battery cell further includes a terminal to allow the electrode assembly to be electrically connected to the outside of the case. The battery cell is connected to the bus bar through the terminal to be electrically connected to the outside.

The battery cell must be firmly fixed to the bus bar because, if the battery cell is separated from the bus bar due to internal or external impact, safety or performance issues with the battery cell may occur. Accordingly, the battery cell is typically fixed to the bus bar by welding the terminal to the bus bar.

However, a problem may occur in one battery cell among the plurality of battery cells included in the battery module. For example, a problem such as deterioration or a vent opening may occur in one battery cell. If the battery cell in which a problem occurs is firmly fixed to the bus bar through welding, it is difficult to separate only the corresponding battery cell from the bus bar. Accordingly, even if a problem occurs in only one battery cell, the entire battery module may need to be discarded. Further, in this case, a large amount of waste is generated, which also causes problems from an environmental perspective.

The above-described information disclosed in the background technology of the present invention is provided to improve understanding of the background of the present invention and thus may include information that does not form the related art.

### SUMMARY

According to an aspect of embodiments of the present disclosure, a battery module, and a battery pack, allow at least one battery cell to be separated.

For example, according to an aspect of embodiments of the present invention, a battery module, and/or a battery pack, allows at least one battery cell to be separated from a bus bar that is electrically connected to a plurality of battery cells.

According to another aspect of embodiments of the present invention, a battery module that allows a new battery cell to be added in place of a separated battery cell is provided.

According to another aspect of embodiments of the present invention, a battery module that allows easy connection between a new battery cell and a bus bar is provided.

According to another aspect of embodiments of the present invention, a battery pack including the above-described battery module in a plural number is provided.

However, aspects and problems to be solved by the present invention are not limited to the above-mentioned aspects and problems, and other aspects and problems not mentioned can be clearly understood by those skilled in the art from the following description.

According to an aspect of one or more embodiments of the present invention, a battery module includes a plurality of battery cells each including a terminal on at least one side, a bus bar configured to electrically connect at least some of the plurality of battery cells, and a coupling portion configured to couple the terminal and the bus bar through a magnetic force.

According to another aspect of the present invention, a battery pack includes the above-described battery modules, and a pack case that accommodates the plurality of battery modules.

### BRIEF DESCRIPTION OF THE DRAWINGS

The following drawings included with the present specification illustrate some example embodiments of the present invention, and serve to further set forth the technical spirit of the present invention together with the detailed description of the present invention provided herein; however, the present invention is not to be construed as being limited to details shown in the accompanying drawings.

FIGS. 1 to 4 are views each schematically illustrating a battery (e.g., a lithium battery) according to some embodiments;

FIG. 5 is a view illustrating a battery module according to an embodiment of the present invention;

FIG. 6 is a schematic cross-sectional view of the battery module according to an embodiment of the present invention;

FIG. 7A to 7D are cross-sectional views schematically illustrating examples in which a coupling portion is located on a bus bar, according to some embodiments of the present invention;

FIG. 8A to 8D are cross-sectional views schematically illustrating examples in which the coupling portion is located on a terminal, according to some embodiments of the present invention;

FIG. 9 is a cross-sectional view schematically illustrating an example in which the coupling portion is located on the bus bar and the terminal, according to an embodiment of the present invention;

FIGS. 10A and 10B are cross-sectional views schematically illustrating an example of a region “A” of FIG. 9;

FIG. 11 is a flowchart describing an example of a method of driving the battery module according to an embodiment of the present invention;

FIG. 12 is a view illustrating a battery pack according to an embodiment of the present invention;

FIG. 13 is a view illustrating the battery pack according to an embodiment of the present invention; and

FIG. 14 is a view illustrating a vehicle body and body parts according to an embodiment of the present invention.

### DETAILED DESCRIPTION

Herein, one or more embodiments of the present invention will be described in further detail. However, this is presented as an example, and the present invention is not limited thereby, but, rather, is to be defined by the scope of the claims. The terms or words used in this specification and claims are not to be construed as being limited to the usual or dictionary meaning and are to be interpreted as having meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

Unless otherwise specified herein, when a part, such as a layer, a film, an area, or a plate, is described as being “on” another part, this includes not only a case in which the part is “directly on” another part, but also a case in which still another part is present therebetween.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Unless otherwise specified herein, a singular expression may also include a plural meaning. In addition, unless otherwise specified, “A or B” may mean “including A, including B, or including A and B.”

As used herein, “a combination thereof” may mean a mixture, a laminate, a composite, a copolymer, an alloy, a blend, a reaction product, and the like of components.

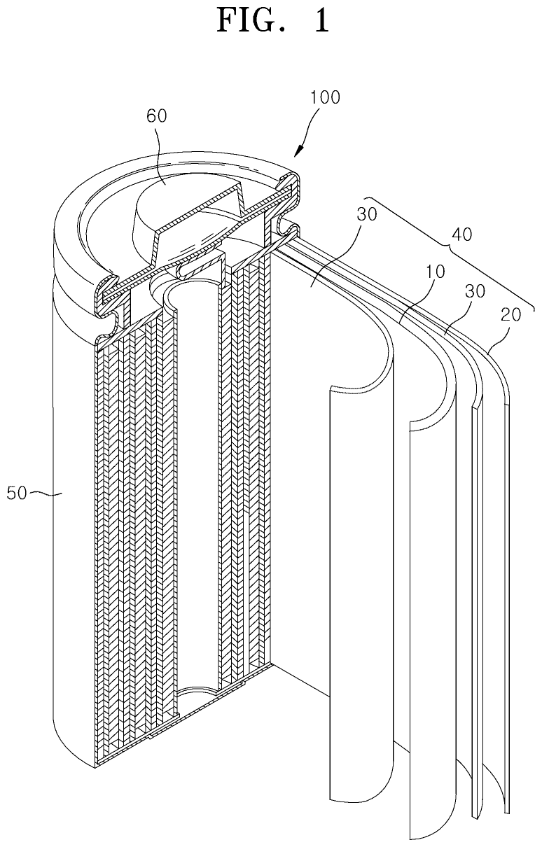

FIGS. 1 to 4 are views each schematically illustrating a battery (e.g., a lithium battery) according to an embodiment.

### Lithium Battery 100

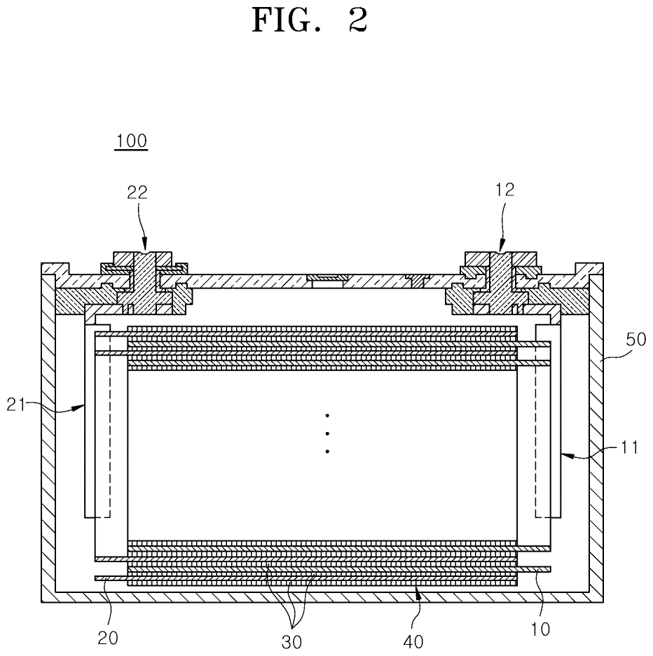

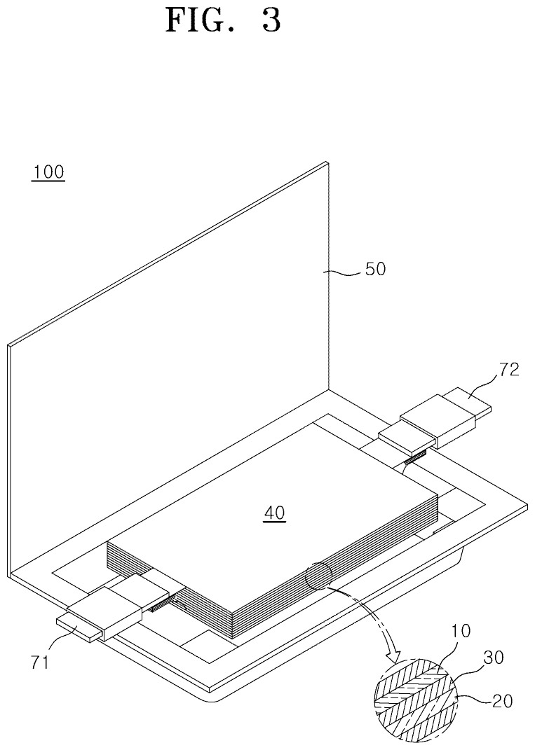

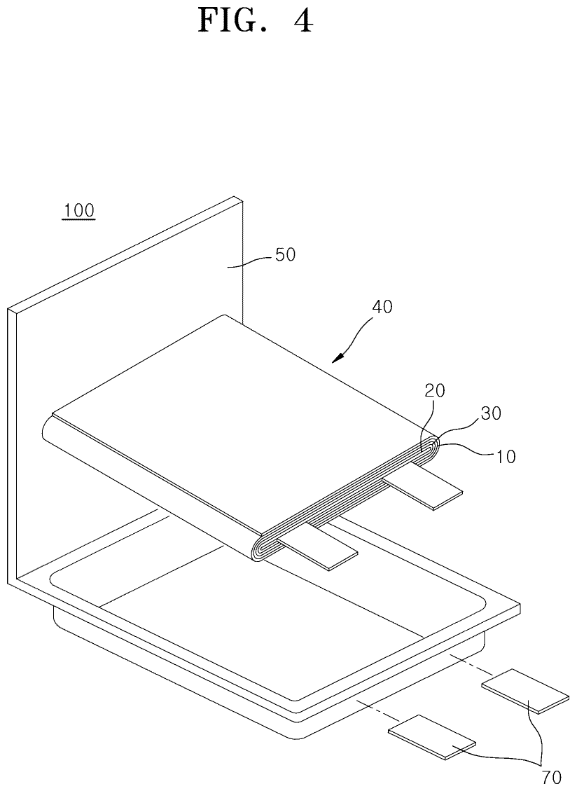

A battery (e.g., a lithium battery) 100 may be classified as any of cylindrical, prismatic, pouch-type, and coin-type batteries, for example, according to a shape thereof. FIGS. 1 to 4 are schematic views each illustrating the lithium battery according to an embodiment, in which FIG. 1 illustrates a cylindrical battery, FIG. 2 illustrates a prismatic battery, and FIGS. 3 and 4 illustrate pouch-type batteries. Referring to FIGS. 1 to 4, the lithium battery 100 may include an electrode assembly 40 including a separator 30 interposed between a positive electrode 10 and a negative electrode 20, and a case 50 in which the electrode assembly 40 is housed. The positive electrode 10, the negative electrode 20, and the separator 30 may be impregnated with an electrolyte (not shown). As shown in FIG. 1, the lithium battery 100 may include a sealing member 60 that seals the case 50. As shown in FIG. 2, the lithium battery 100 may include a positive electrode lead tab 11, a positive electrode terminal 12, a negative electrode lead tab 21, and a negative electrode terminal 22. As shown in FIGS. 3 and 4, the lithium battery 100 may include electrode tabs 70, that is, a positive electrode tab 71 and a negative electrode tab 72, which function as electrical paths for inducing a current formed in the electrode assembly 40 to the outside.

### Positive Electrode Active Material

As a positive electrode active material, a compound (a lithiated intercalation compound) that is capable of reversible intercalation and deintercalation of lithium may be used. In an embodiment, one or more of a composite oxide of lithium and a metal selected from cobalt, manganese, nickel, and a combination thereof may be used.

The composite oxide may be a lithium-transition metal composite oxide, and examples thereof may include lithium nickel-based oxide, lithium cobalt-based oxide, lithium manganese-based oxide, lithium iron phosphate-based compound, cobalt-free nickel-manganese-based oxide, or a combination thereof.

As an example, compounds represented by any one of the following chemical formulas may be used. LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); or Li_{(3-f)}Fe₂(PO₄)₃(0≤f≤2); LiₐFePO₄(0.90≤a≤1.8).

In the above chemical formulas, A is Ni, Co, Mn, or a combination thereof; X is Al, Ni, Co, Mn, Cr, Fe, Mg, Sr, V, a rare-earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

As an example, the positive electrode active material may be a high-nickel-based positive electrode active material having a nickel content of greater than or equal to 80 mol %, greater than or equal to 85 mol %, greater than or equal to 90 mol %, greater than or equal to 91 mol %, or greater than or equal to 94 mol % and less than or equal to 99 mol % based on 100 mol % of the metal excluding lithium in the lithium-transition metal composite oxide. The high-nickel-based positive electrode active material may be capable of realizing high capacity and can be applied to high-capacity and high-density lithium batteries.

### Positive Electrode 10

The positive electrode 10 of the lithium battery 100 may include a current collector and a positive electrode active material layer formed on the current collector. The positive electrode active material layer includes a positive electrode active material and may further include a binder and/or a conductive material.

As an example, the positive electrode may further include an additive that can function as a sacrificial positive electrode.

In an embodiment, a content of the positive electrode active material may be 90 wt % to 99.5 wt % based on 100 wt % of the positive electrode active material layer, and a content of each of the binder and the conductive material may be 0.5 wt % to 5 wt % based on 100 wt % of the positive electrode active material layer.

The binder adheres positive electrode active material particles to each other and also adheres the positive electrode active material to the current collector. Some examples of the binder include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, or the like, but the present invention is not limited thereto.

The conductive material provides conductivity to the electrode, and any suitable material that does not cause a chemical change and is electrically conductive may be used in the configured battery. Examples of the conductive material may include a carbon-based material, such as natural graphite, artificial graphite, carbon black, acetylene black, Ketjen black, carbon fibers, or carbon nanofibers; a metal-based material in the form of a metal powder or metal fiber including copper, nickel, aluminum, silver, or the like; a conductive polymer, such as a polyphenylene derivative; or a mixture thereof.

In an embodiment, Al may be used as the current collector, but the present invention is not limited thereto.

### Negative Electrode Active Material

A negative electrode active material may include a material capable of reversible intercalation/deintercalation of lithium ions, a lithium metal, a lithium metal alloy, a material capable of doping and dedoping lithium, or a transition metal oxide.

The material capable of reversible intercalation/deintercalation of lithium ions is a carbon-based negative electrode active material, and may include, for example, crystalline carbon, amorphous carbon, or a combination thereof. Examples of the crystalline carbon may include graphite, such as amorphous, plate shape, flake, spherical shape or fiber-shaped natural graphite or artificial graphite. Examples of the amorphous carbon may include soft carbon or hard carbon, a mesophase pitch carbonized product, calcined coke, and the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

A Si-based negative electrode active material or a Sn-based negative electrode active material may be used as the material capable of doping and dedoping lithium. The Si-based negative electrode active material may include silicon, a silicon-carbon composite, SiOx (0<x≤2), a Si-Q alloy (where, Q is selected from an alkali metal, an alkaline-earth metal, a Group 13 element, a Group 14 element (excluding Si), a Group 15 element, a Group 16 element, a transition metal, a rare-earth element, and a combination thereof), or a combination thereof. The Sn-based negative electrode active material may be Sn, SnO₂, a Sn-based alloy, or a combination thereof.

The silicon-carbon composite may be a composite of silicon and amorphous carbon. According to an embodiment, the silicon-carbon composite may be in the form of silicon particles and amorphous carbon coated on the surface of the silicon particles. For example, the silicon-carbon composite may include a secondary particle (core) in which silicon primary particles are agglomerated and an amorphous carbon coating layer (shell) located on the surface of the secondary particle. The amorphous carbon may be located between the silicon primary particles, such that, for example, the silicon primary particles are coated with amorphous carbon. The secondary particles may be dispersed in an amorphous carbon matrix.

The silicon-carbon composite may further include crystalline carbon. For example, the silicon-carbon composite may include a core including crystalline carbon and silicon particles and an amorphous carbon coating layer located on the surface of the core.

The Si-based negative electrode active material or the Sn-based negative electrode active material may be used by being mixed with a carbon-based negative electrode active material.

### Negative Electrode 20

The negative electrode 20 of the lithium battery 100 includes a current collector and a negative electrode active material layer located on the current collector. The negative electrode active material layer includes a negative electrode active material and may further include a binder and/or a conductive material.

For example, the negative electrode active material layer may include 90 wt % to 99 wt % of the negative electrode active material, 0.5 wt % to 5 wt % of the binder, and 0 wt % to 5 wt % of the conductive material.

The binder adheres negative electrode active material particles to each other and also adheres the negative electrode active material to the current collector. A non-aqueous binder, an aqueous binder, a dry binder, or a combination thereof may be used as the binder.

The non-aqueous binder may include polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, fluororubber, a polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, and a combination thereof.

If the aqueous binder is used as the negative electrode binder, a cellulose-based compound capable of imparting viscosity can be further included. As the cellulose-based compound, one or more of carboxymethyl cellulose, hydroxypropylmethyl cellulose, methyl cellulose, or alkali metal salts thereof may be used in combination. Na, K, or Li can be used as the alkali metal.

The dry binder is a polymer material capable of being fiberized, and may be, for example, polytetrafluoroethylene, polyvinylidene fluoride, a polyvinylidene fluoride-hexafluoropropylene copolymer, a polyethylene oxide, or a combination thereof.

The conductive material provides conductivity to the electrode, and any suitable material that does not cause a chemical change and is electrically conductive may be used in the configured battery. Specific examples of the conductive material may include a carbon-based material, such as natural graphite, artificial graphite, carbon black, acetylene black, Ketjen black, carbon fibers, or carbon nanofibers; a metal-based material in the form of a metal powder or metal fiber including copper, nickel, aluminum, silver, or the like; a conductive polymer, such as a polyphenylene derivative; or a mixture thereof.

In an embodiment, the negative electrode current collector may be selected from a copper foil, a nickel foil, a stainless steel foil, a titanium foil, a nickel foam, a copper foam, a polymer substrate coated with a conductive metal, and a combination thereof.

### Electrolyte (Not Shown)

The electrolyte of the lithium battery 100 includes a non-aqueous organic solvent and a lithium salt.

The non-aqueous organic solvent functions as a medium through which ions taking part in the electrochemical reaction of a battery can move.

The non-aqueous organic solvent may be a carbonate-based, ester-based, ether-based, ketone-based, alcohol-based solvent, aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (MEC), ethylene carbonate (EC), propylene carbonate (PC), butylene carbonate (BC), and the like.

The ester-based solvent may include methyl acetate, ethyl acetate, n-propyl acetate, dimethyl acetate, methyl propionate, ethyl propionate, decanolide, mevalonolactone, and valerolactone, caprolactone, and the like.

The ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvent may include ethyl alcohol, isopropyl alcohol, and the like, and the aprotic solvent may include nitriles such as R-CN (where R is a C2 to C20 linear, branched, or cyclic hydrocarbon group and includes a double bond, an aromatic ring, or an ether bond), and the like; amides such as dimethyl formamide; dioxolanes such as 1,3-dioxolane and 1,4-dioxolane; sulfolanes; and the like.

The non-aqueous organic solvents may be used alone or in combination of two or more.

In an embodiment, if a carbonate-based solvent is used, a cyclic carbonate and a chain carbonate may be mixed and used, and the cyclic carbonate and the chain carbonate may be mixed in a volume ratio of 1:1 to 1:9.

The lithium salt is a material that is dissolved in the organic solvent and serves as a source of lithium ions in a battery, enables a basic operation of a lithium battery, and improves the movement of the lithium ions between positive and negative electrodes. Some examples of the lithium salt may include one or two or more selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where, x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

### Separator 30

Depending on the type of the lithium battery 100, the separator 30 may be present between the positive electrode 10 and the negative electrode 20. The separator 30 may include polyethylene, polypropylene, polyvinylidene fluoride, or a multilayer film of two or more layers thereof, and may include a mixed multilayer film, such as a polyethylene/polypropylene two-layer separator, a polyethylene/polypropylene/polyethylene three-layer separator, a polypropylene/polyethylene/polypropylene three-layer separator, or the like.

The separator 30 may include a porous substrate and a coating layer including an organic material, an inorganic material, or a combination thereof located on one surface or both, or opposite, surfaces of the porous substrate.

The porous substrate may be a polymer film formed of a polymer, or a copolymer or a mixture of two or more selected from polyolefins, such as polyethylene, polypropylene, and the like, polyesters, such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, a polyphenylene oxide, a cyclic olefin copolymer, polyphenylene sulfide, polyethylene naphthalate, a glass fiber, and polytetrafluoroethylene (e.g., Teflon).

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present invention is not limited thereto.

The organic and inorganic materials may be present by being mixed in one coating layer or may be present in a form in which a coating layer including organic materials and a coating layer including inorganic materials are stacked.

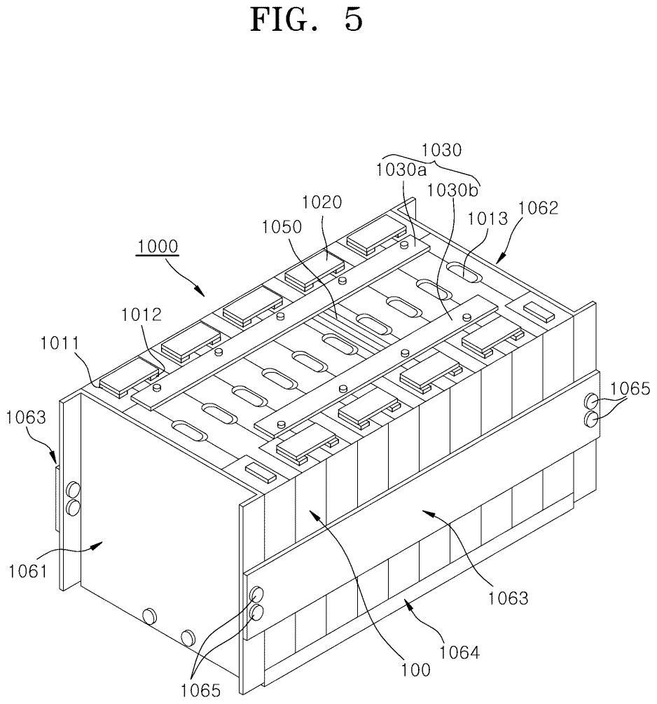

FIG. 5 is a view illustrating a battery module according to an embodiment of the present invention.

A battery module 1000 according to an embodiment of the present invention includes a plurality of battery cells 100, a housing 1061, 1062, 1063, 1064, and 1065 in which the plurality of battery cells 100 is accommodated, and bus bars that electrically connect at least some of the plurality of battery cells 100.

The plurality of battery cells 100 may include, for example, any of the battery cells 100 described in FIGS. 1 to 4 and may be accommodated by being arranged in a direction in the housing 1061 to 1065.

In an embodiment, the housing 1061 to 1065 may include a pair of end plates 1061 and 1062 facing a wide surface of each of the battery cells 100, side plates 1063 that connect the pair of end plates 1061 and 1062, and a bottom plate 1064. The side plates 1063 may support side surfaces of each of the battery cells 100, and the bottom plate 1064 may support a bottom surface of each of the battery cells 100. The pair of end plates 1061 and 1062, the side plates 1063, and the bottom plate 1064 may be connected to each other by connecting members (e.g., bolts) 1065.

The battery module 1000 includes terminal portions 1011 and 1012, connection tabs 1020 connecting adjacent battery cells 100, and a protection circuit module 1030 having a side end portion connected to the connection tabs 1020. In an embodiment, the protection circuit module 1030 may be a battery management system (BMS). In an embodiment, the connection tabs 1020 may be bus bars.

In an embodiment, the terminal portions 1011 and 1012, which are electrically connected to the connection tab 1020, and a vent 1013, which is an exhaust path for gas generated inside, may be provided on a side of the battery cell 100. The terminal portions 1011 and 1012 of the battery cell 100 may be a positive electrode terminal 1011 and a negative electrode terminal 1012 having different polarities, and the terminal portions 1011 and 1012 of the battery cells 100 adjacent to each other may be electrically connected in series or in parallel by the connection tab 1020 to be described below. However, while a series connection has been described above as an example, the present invention is not limited to such a structure, and various connection structures may be adopted as needed. In addition, a number and arrangement of the battery cells are not limited to the structure shown in FIG. 5 and may be changed as desired.

The protection circuit module 1030 may include electronic components, protection circuits, and the like mounted therein and may be electrically connected to the connection tabs 1020 to be described below. In an embodiment, the protection circuit module 1030 includes a first protection circuit module 1030a and a second protection circuit module 1030b extending at different positions in a direction in which the plurality of battery cells 100 are arranged, and the first protection circuit module 1030a and the second protection circuit module 1030b may be spaced apart from each other at a distance (e.g., a predetermined distance) and located parallel to each other, and may each be electrically connected to the adjacent connection tabs 1020. For example, the first protection circuit module 1030a is formed to extend on a side of an upper portion of each of the plurality of battery cells 100 in the direction in which the battery cells 100 are arranged. The second protection circuit module 1030b is formed to extend on the other side of the upper portion of each of the plurality of battery cells 100 in the direction in which the battery cells 100 are arranged, and may be located to be spaced apart from the first protection circuit module 1030a at a distance (e.g., a predetermined distance) with the vents 1013 interposed therebetween and disposed parallel to the first protection circuit module 1030a. As described above, the two protection circuit modules are disposed in parallel to be spaced apart from each other in the direction in which the battery cells 100 are arranged, thereby minimizing or reducing an area of a printed circuit board (PCB) constituting the protection circuit module 1030. By configuring the protection circuit module 1030 separately into two protection circuit modules, a PCB area is minimized or reduced. In addition, the first protection circuit module 1030a and the second protection circuit module 1030b may be connected to each other by a connecting member 1050 having conductivity. In this case, a side of the connecting member 1050 may be connected to the first protection circuit module 1030a, and another side of the connecting member 1050 may be connected to the second protection circuit module 1030b, thereby allowing an electrical connection between the two protection circuit modules.

The connection may be performed by any of soldering, resistance welding, laser welding, and projection welding methods, for example.

In an embodiment, the connecting member 1050 may be, for example, an electrical wire. In an embodiment, the connecting member 1050 may be made of an elastic or flexible material. With the connecting member 1050, whether the voltage, temperature, and current of the plurality of battery cells 100 are normal may be checked and managed. That is, information such as voltage, current, and temperature received by the first protection circuit module 1030a from the connection tabs adjacent to the first protection circuit module 1030a and information such as voltage, current, and temperature received by the second protection circuit module 1030b from the connection tabs adjacent to the second protection circuit module 1030b may be integrated and managed by the protection circuit module 1030 through the connecting member 1050.

If the battery cell 100 swells, an impact may be absorbed by the elasticity or flexibility of the connecting member 1050, thereby preventing or substantially preventing damage to the first and second protection circuit modules 1030a and 1030b.

However, a shape and structure of the connecting member 1050 are not limited to those shown in FIG. 5.

As described above, as the protection circuit module 1030 is comprised of the first and second protection circuit modules 1030a and 1030b, the area of the PCB constituting the protection circuit module can be minimized or reduced, thereby securing a space inside the battery module. This improves work efficiency by facilitating not only a coupling work of connecting the connection tab 1020 and the protection circuit module 1030, but also a repair work when an abnormality is detected in the battery module.

As described in FIGS. 1 to 5, the battery module 1000 according to an embodiment of the present invention includes the plurality of battery cells 100 and the housing 1061 to 1065 in which the plurality of battery cells 100 are accommodated. The battery module 1000 includes a bus bar (e.g., including the bus bar described in FIG. 5) that electrically connects at least two of the plurality of battery cells 100. Herein, the battery module 1000 in which the bus bar and the plurality of battery cells 100 are connected will be described.

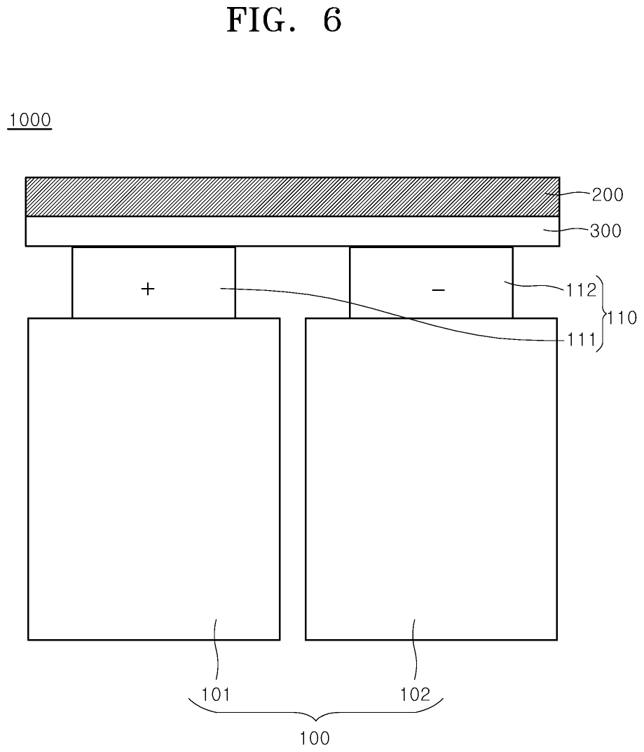

FIG. 6 is a schematic cross-sectional view of the battery module according to an embodiment of the present invention.

In FIG. 6, “1000” denotes a battery module according to an embodiment of the present invention (e.g., including the battery module described in FIG. 5).

The battery module 1000 according to an embodiment includes a plurality of battery cells 100 (e.g., including the lithium battery 100 and/or the battery cell 100 described in FIGS. 1 to 5), a bus bar 200, and a coupling portion 300.

Each of the plurality of battery cells 100 includes the electrode assembly 40 and the case 50 that accommodates the electrode assembly 40. The plurality of battery cells 100 include, for example, a first battery cell 101 and a second battery cell 102.

Terminals 110 (e.g., the terminal portions 1011 and 1012 described with respect to FIG. 5) are formed on at least one side of each of the battery cells 100. The terminals 110 allow the electrode assembly 40 to be electrically connected to the outside. The terminal 110 may be located partially or entirely on an outside of the case 50. The terminals 110 function as paths through which the electrode assembly 40 can charge and/or discharge electrical energy from and to the outside.

The terminals 110 include a conductive material. For example, the terminals 110 may include a metal. For example, the metal may include at least one selected from among copper (Cu), nickel (Ni), gold (Au), silver (Ag), platinum (Pt), magnesium (Mg), tin (Sn), iron (Fe), and a combination thereof. However, the above are described by way of example, and the terminal 110 may be made of any suitable material that conducts current.

The terminals 110 include a negative electrode terminal and a positive electrode terminal, as described above. The negative electrode terminal is electrically connected to the negative electrode 20 included in the electrode assembly 40. The positive electrode terminal is electrically connected to the positive electrode 10 included in the electrode assembly 40.

In FIG. 6, a positive electrode terminal 111 of the first battery cell 101 and a negative electrode terminal 112 of the second battery cell 102 are illustrated as an example.

The bus bar 200 electrically connects at least some of the plurality of battery cells 100. The bus bar 200 electrically connects, for example, the first battery cell 101 and the second battery cell 102. For example, as shown in FIG. 6, the bus bar 200 electrically connects the positive electrode terminal 111 of the first battery cell 101 and the negative electrode terminal 112 of the second battery cell 102. The bus bar 200 may be connected, for example, to the protection circuit module described in FIG. 5.

The bus bar 200 includes, for example, a conductive material. The conductive material may include, for example, a metal. For example, the metal may include at least one selected from among copper (Cu), aluminum (Al), nickel (Ni), gold (Au), silver (Ag), platinum (Pt), magnesium (Mg), tin (Sn), iron (Fe), and a combination thereof. However, these are described by way of example, and the bus bar 200 may be made of any suitable material that conducts current.

If the battery cell 100 is not firmly fixed to the bus bar 200, the battery cell 100 may be separated from the bus bar 200 due to an internal or external impact or a change in a surrounding environment. In this case, due to the separated battery cell 100, all or a portion of the battery module may not properly perform an electrical energy charging and discharging. Further, a safety problem may occur in all or a portion of the battery module.

However, if the battery cell 100 is firmly fixed to the bus bar 200, the battery cell 100 may not be separated from the bus bar 200, even in situations in which separation of the battery cell 100 is desired. In this case, the battery cell 100 is damaged to separate the battery cell 100. In this case, the damaged battery cell is difficult to further recycle. Further, in the process of separating the battery cell 100, the bus bar 200 or other battery cells located around the corresponding battery cell 100 may be additionally damaged.

Accordingly, it is desired that the battery cell 100 be firmly fixed to the bus bar 200 while also being easily separable from the bus bar 200 when necessary. To this end, the battery module 1000 according to an embodiment of the present invention includes the coupling portion 300.

The coupling portion 300 allows the terminal 110 and the bus bar 200 to be coupled through a magnetic force. In this case, the term “magnetic force” refers to a force generated by magnetic objects, and may be used interchangeably with the term “magnetism.”

The coupling portion 300 is provided between the terminal 110 and the bus bar 200 to couple the terminal 110 to the bus bar 200. For example, the coupling portion 300 is provided above the terminal 110. For example, the coupling portion 300 is provided below the bus bar 200.

In an embodiment, the coupling portion 300 is coupled to the bus bar 200, which contains, for example, a conductive material, through a magnetic force. In another embodiment, the coupling portion 300 is coupled to the terminal 110, which contains, for example, a conductive material, through a magnetic force. That is, an upper surface of the coupling portion 300 may be coupled to the bus bar 200 through a magnetic force, and a lower surface of the coupling portion 300 may be coupled to the terminal 110 through a magnetic force. With this configuration, the coupling portion 300 can be connected to either the bus bar 200 or the terminal 110 without separate welding.

However, in an embodiment, the coupling portion 300 may be bonded to the bus bar 200 by being welded to a lower portion of the bus bar 200. In this case, for example, the upper surface of the coupling portion 300 may be bonded to the bus bar 200 through welding, and the lower surface of the coupling portion 300 may be coupled to the terminal 110 through a magnetic force. In an embodiment, the terminal 110 may include a magnetic material. The magnetic material may include, for example, a ferromagnetic material, and may include, for example, the above-described conductive material. Accordingly, the bus bar 200 includes the coupling portion 300, which functions as a permanent magnet, and can be coupled to the terminal 110, which is a magnetic material. With this configuration, the coupling portion 300 allows a firm attachment of the bus bar 200, while facilitating the separation or coupling of the terminal 110.

In an embodiment, the coupling portion 300 may be bonded to the terminal 110 by being welded to an upper portion of the terminal 110. In this case, for example, the upper surface of the coupling portion 300 may be coupled to the bus bar 200 through a magnetic force, and the lower surface of the coupling portion 300 may be bonded to the terminal 110 through welding. In an embodiment, the bus bar 200 may include a magnetic material. The magnetic material may include, for example, a ferromagnetic material, and may include, for example, the above-described conductive material. Accordingly, the terminal 110 includes the coupling portion 300, which functions as a permanent magnet, and can be coupled to the bus bar 200, which is a magnetic material. With this configuration, the coupling portion 300 can be mass-produced along with the battery cell 100, thereby improving process convenience.

As described above, the bus bar 200 and the terminal 110 are not welded to each other but are coupled through a magnetic force of the coupling portion 300. Accordingly, the battery cell 100 can be separated from the bus bar 200 without damage. Further, a new battery cell 100 can be coupled to the bus bar 200 in a place where the battery cell 100 is separated. The new battery cell 100 can be easily coupled to the bus bar 200 through a magnetic force without separate welding.

In an embodiment, the coupling portion 300 generates a tensile force, for example, greater than or equal to 300 N and less than or equal to 2500 N. In an embodiment, the coupling portion 300 generates a tensile force, for example, greater than or equal to 300 N and less than or equal to 2400 N. In an embodiment, the coupling portion 300 generates a tensile force, for example, greater than or equal to 300 N and less than or equal to 2300 N. In an embodiment, the coupling portion 300 generates a tensile force, for example, greater than or equal to 300 N and less than or equal to 2200 N. In an embodiment, the coupling portion 300 generates a tensile force, for example, greater than or equal to 300 N and less than or equal to 2100 N. In an embodiment, the coupling portion 300 generates a tensile force, for example, greater than or equal to 300 N and less than or equal to 2000 N. In an embodiment, the coupling portion 300 generates a tensile force, for example, greater than or equal to 500 N and less than or equal to 2500 N. In an embodiment, the coupling portion 300 generates a tensile force, for example, greater than or equal to 500 N and less than or equal to 2400 N. In an embodiment, the coupling portion 300 generates a tensile force, for example, greater than or equal to 500 N and less than or equal to 2300 N. In an embodiment, the coupling portion 300 generates a tensile force, for example, greater than or equal to 500 N and less than or equal to 2200 N. In an embodiment, the coupling portion 300 generates a tensile force, for example, greater than or equal to 500 N and less than or equal to 2100 N. In an embodiment, the coupling portion 300 generates a tensile force, for example, greater than or equal to 500 N and less than or equal to 2000 N. In an embodiment, the coupling portion 300 generates a tensile force, for example, greater than or equal to 1000 N and less than or equal to 2500 N. In an embodiment, the coupling portion 300 generates a tensile force, for example, greater than or equal to 1000 N and less than or equal to 2400 N. In an embodiment, the coupling portion 300 generates a tensile force, for example, greater than or equal to 1000 N and less than or equal to 2300 N. In an embodiment, the coupling portion 300 generates a tensile force, for example, greater than or equal to 1000 N and less than or equal to 2200 N. In an embodiment, the coupling portion 300 generates a tensile force, for example, greater than or equal to 1000 N and less than or equal to 2100 N. In an embodiment, the coupling portion 300 generates a tensile force, for example, greater than or equal to 1000 N and less than or equal to 2000 N.

If the tensile force of the coupling portion 300 is less than 300 N, the battery cell 100 may be separated from the bus bar 200 due to an external vibration or impact. If the tensile force of the coupling portion 300 is greater than 2500 N, it may be difficult to separate the battery cell 100 from the bus bar 200, or the battery cell 100 and/or the bus bar 200 may be damaged by the tensile force. Accordingly, it is desirable for the coupling portion 300 to generate a tensile force greater than or equal to 300 N and less than or equal to 2500 N.

In an embodiment, the coupling portion 300 includes at least one selected from the group consisting of a neodymium iron boron (NdFeB) magnet, a samarium cobalt (SmCo) magnet, a ferrite magnet, and a combination thereof. However, the material of the coupling portion 300 is not limited thereto, and the coupling portion 300 may include any suitable component that generates a magnetic force. For example, the coupling portion 300 may include at least one of a ferrite magnet, an alnico magnet, and a rubber magnet. Further, the coupling portion 300 may include any suitable material including an S-pole and an N-pole.

A size of the coupling portion 300, including a cross-sectional area and thickness of the coupling portion 300, may be determined, for example, depending on the material of the coupling portion 300. If the coupling portion 300 includes, for example, a NdFeB magnet, the coupling portion 300 may be relatively small. If the coupling portion 300 includes, for example, a rubber magnet, the coupling portion 300 may be relatively large. However, the size of the coupling portion 300 may be set according to the specifications required for the battery module 1000, the tensile force required for coupling, and the like.

As described in FIG. 6, the plurality of battery cells 100 are fixed to the bus bar 200 through the coupling portion 300. In the fixed state as described above, the plurality of battery cells 100 are housed in the housing 1061 to 1065 described in FIG. 5.

With this configuration, the battery module 1000 according to an embodiment of the present invention may replace a battery cell in which a problem occurs without causing damage to the bus bar or the battery cell. Accordingly, the battery module 1000 may allow a high recycling rate of internal components thereof. In addition, the battery module 1000 may allow a number of discarded parts to be reduced. Accordingly, the battery module 1000 according to an embodiment of the present invention not only facilitates coupling, separation, and/or replacement of the battery cell 100, but also can make a significant contribution in terms of environmental aspects.

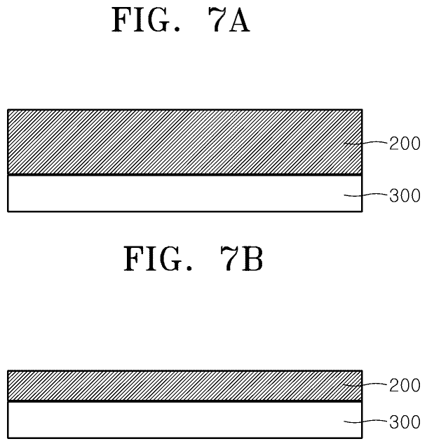

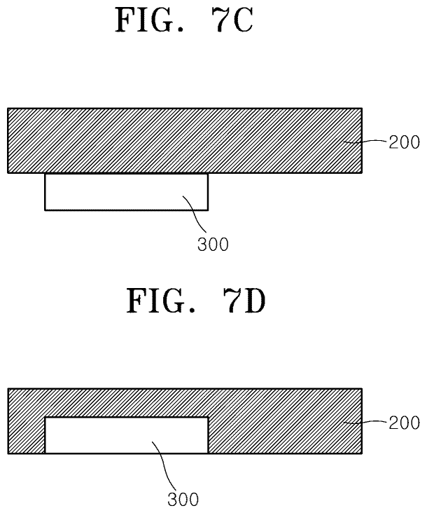

FIGS. 7A to 7D are cross-sectional views schematically illustrating examples in which a coupling portion is located on a bus bar, according to some embodiments of the present invention.

In an embodiment, the coupling portion 300 according to an embodiment of the present invention is formed on a surface of at least one of the terminal 110 and the bus bar 200. In another embodiment, the coupling portion 300 is formed by being embedded in at least one of the terminal 110 and the bus bar 200.

In an embodiment, the coupling portion 300 is formed having an area corresponding to all, or an entirety, of a surface of at least one of the terminal 110 and the bus bar 200. In another embodiment, the coupling portion 300 is formed with an area corresponding to a portion of at least one of the terminal 110 and the bus bar 200.

FIGS. 7A to 7D illustrate examples in which the coupling portion 300 is provided on the bus bar 200. For example, the coupling portion 300 is provided on a lower side of the bus bar 200.

FIG. 7A illustrates an example in which the coupling portion 300 is formed on a surface of the bus bar 200. In addition, FIG. 7A illustrates an example in which the coupling portion 300 is formed having an area corresponding to an entire surface of the bus bar 200. With this structure, the coupling portion 300 according to an embodiment of the present invention can be easily coupled to the bus bar 200. For example, the coupling portion 300 can be applied to a pre-manufactured battery module. Further, the coupling portion 300 according to an embodiment of the present invention provides a strong coupling force with respect to the bus bar 200 and the terminal 110.

FIG. 7B illustrates an example in which the coupling portion 300 is embedded in the bus bar 200. FIG. 7B illustrates an example in which the coupling portion 300 is formed with an area corresponding to an entire surface of the bus bar 200. With this structure, the coupling portion 300 according to an embodiment of the present invention can be strongly coupled to the bus bar 200. Further, the coupling portion 300 according to an embodiment of the present invention provides a strong coupling force with respect to the bus bar 200 and the terminal 110.

FIG. 7C illustrates an example in which the coupling portion 300 is formed on a surface of the bus bar 200. FIG. 7C illustrates an example in which the coupling portion 300 is formed with an area corresponding to a portion of a surface of the bus bar 200. With this structure, the coupling portion 300 according to an embodiment of the present invention can be easily coupled to the bus bar 200. For example, the coupling portion 300 can be applied to a pre-manufactured battery module. In addition, the coupling portion 300 according to an embodiment of the present invention provides a strong coupling force with respect to the bus bar 200 and the terminal 110 while reducing material costs.

However, the coupling portion 300 may be formed in any of various shapes. For example, the coupling portion 300 may have any of shapes that can be implemented, such as any of a “C” shape, a donut shape, polygonal shapes including a triangular shape, a quadrangular shape, a pentagonal shape, a hexagonal shape, a heptagonal shape, an octagonal shape, and the like, a circular shape, an oval shape, a star shape, and the like. In addition, the coupling portion 300 may be formed with any cross-sectional area size. For example, the coupling portion 300 may be formed with any cross-sectional area size as long as it is smaller than that of the bus bar 200. For example, the coupling portion 300 may be formed with a cross-sectional area smaller than that of the terminal 110. The coupling portion 300 may be located anywhere on the bus bar 200 in a range in which the coupling portion 300 provides a coupling force.

FIG. 7D illustrates an example in which the coupling portion 300 is embedded in the bus bar 200. FIG. 7D illustrates an example in which the coupling portion 300 has an area corresponding to a portion of one surface of the bus bar 200. With this structure, the coupling portion 300 according to an embodiment of the present invention can be strongly coupled to the bus bar 200. In addition, the coupling portion 300 according to an embodiment of the present invention provides a strong coupling force with respect to the bus bar 200 and the terminal 110 while reducing material costs.

The coupling portion 300 may be formed in any of various shapes. For example, the coupling portion 300 may have any of various shapes that can be implemented, such as a “C” shape, a donut shape, polygonal shapes including a triangular shape, a quadrangular shape, a pentagonal shape, a hexagonal shape, a heptagonal shape, an octagonal shape, and the like, a circular shape, an oval shape, a star shape, and the like. The coupling portion 300 may be formed with any cross-sectional area size. For example, the coupling portion 300 may be formed with any cross-sectional area size as long as it is smaller than that of the bus bar 200. For example, the coupling portion 300 may be formed with a cross-sectional area smaller than that of the terminal 110. In addition, the coupling portion 300 may be located anywhere on the bus bar 200 in a range in which the coupling portion 300 provides a coupling force.

As described above, according to an embodiment of the present invention, various embodiments applicable to various factors, such as costs, specifications, tensile force, and the like, can be provided.

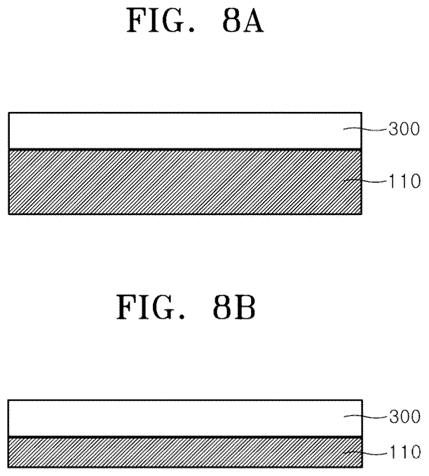

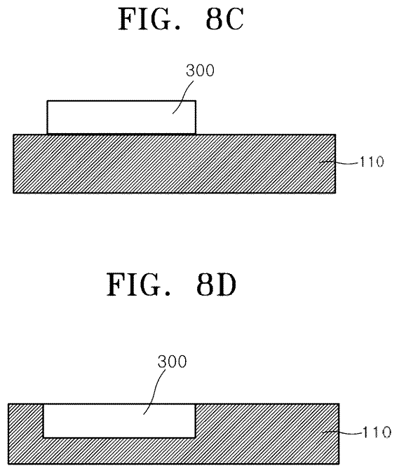

FIGS. 8A to 8D are cross-sectional views schematically illustrating examples in which the coupling portion is located on the terminal, according to some embodiments of the present invention.

In an embodiment, the coupling portion 300 according to an embodiment of the present invention is formed on a surface of at least one of the terminal 110 and the bus bar 200. In another embodiment, the coupling portion 300 is formed by being embedded in at least one of the terminal 110 and the bus bar 200.

The coupling portion 300 according to an embodiment of the present invention is formed with an area corresponding to all, or an entirety, of a surface of at least one of the terminal 110 and the bus bar 200. In another embodiment, the coupling portion 300 is formed with an area corresponding to a portion of at least one of the terminal 110 and the bus bar 200.

FIG. 8A illustrates an example in which the coupling portion 300 is formed on a surface of the terminal 110. FIG. 8A illustrates an example in which the coupling portion 300 is formed with an area corresponding to an entire surface of the terminal 110. With this structure, the coupling portion 300 according to an embodiment of the present invention can be easily coupled to the terminal 110. For example, the coupling portion 300 can be applied to a pre-manufactured battery module. Further, the coupling portion 300 according to an embodiment of the present invention provides a strong coupling force with respect to the bus bar 200 and the terminal 110.

FIG. 8B illustrates an example in which the coupling portion 300 is embedded in the terminal 110. In addition, FIG. 8B illustrates an example in which the coupling portion 300 is formed with an area corresponding to an entire surface of the terminal 110. With this structure, the coupling portion 300 according to an embodiment of the present invention can be strongly coupled to the terminal 110. Further, the coupling portion 300 according to an embodiment of the present invention provides a strong coupling force with respect to the bus bar 200 and the terminal 110.

FIG. 8C illustrates an example in which the coupling portion 300 is formed on a surface of the terminal 110. FIG. 8C illustrates an example in which the coupling portion 300 is formed with an area corresponding to a portion of a surface of the terminal 110. With this structure, the coupling portion 300 according to an embodiment of the present invention can be easily coupled to the terminal 110. For example, the coupling portion 300 can be applied to a pre-manufactured battery module. In addition, the coupling portion 300 according to an embodiment of the present invention provides a strong coupling force with respect to the bus bar 200 and the terminal 110 while reducing material costs.

The coupling portion 300 may be formed in any of various shapes. For example, the coupling portion 300 may have any of suitable shapes that can be implemented, such as a “C” shape, a donut shape, polygonal shapes including a triangular shape, a quadrangular shape, a pentagonal shape, a hexagonal shape, a heptagonal shape, an octagonal shape, and the like, a circular shape, an oval shape, a star shape, and the like. In addition, the coupling portion 300 may be formed with any suitable cross-sectional area size. For example, the coupling portion 300 may be formed with any suitable cross-sectional area size as long as it is smaller than that of the terminal 110. For example, the coupling portion 300 may be formed with a cross-sectional area smaller than that of the terminal 110. In addition, the coupling portion 300 may be located anywhere on the terminal 110 in a range in which the coupling portion 300 provides a coupling force.

FIG. 8D illustrates an example in which the coupling portion 300 is embedded in the terminal 110. FIG. 8D illustrates an example in which the coupling portion 300 is formed with an area corresponding to a portion of a surface of the terminal 110. With this structure, the coupling portion 300 according to an embodiment of the present invention can be strongly coupled to the terminal 110. In addition, the coupling portion 300 according to an embodiment of the present invention provides a strong coupling force with respect to the bus bar 200 and the terminal 110 while reducing material costs.

The coupling portion 300 may be formed in any of various shapes. For example, the coupling portion 300 may have any of various shapes that can be implemented, such as a “C” shape, a donut shape, polygonal shapes including a triangular shape, a quadrangular shape, a pentagonal shape, a hexagonal shape, a heptagonal shape, an octagonal shape, and the like, a circular shape, an oval shape, a star shape, and the like. In addition, the coupling portion 300 may be formed with any suitable cross-sectional area size. For example, the coupling portion 300 may be formed with any suitable cross-sectional area size as long as it is smaller than that of the terminal 110. For example, the coupling portion 300 may be formed with a cross-sectional area smaller than that of the terminal 110. In addition, the coupling portion 300 may be located anywhere on the terminal 110 in a range in which the coupling portion 300 provides a coupling force.

As described above, according to an embodiment of the present invention, various embodiments applicable to various factors such as costs, specifications, tensile force, and the like can be provided.

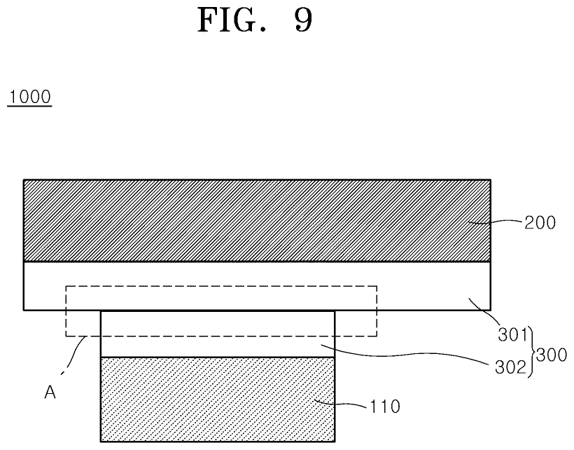

FIG. 9 is a cross-sectional view schematically illustrating an example in which the coupling portion is located on the bus bar and the terminal, according to an embodiment of the present invention.

In FIG. 9, for convenience of description, a case in which the coupling portion 300 is formed on a surface of each of the terminal 110 and the bus bar 200 is illustrated as an example. In FIG. 9, for convenience of description, a case in which the coupling portion 300 is formed with an area corresponding to an entire cross-sectional area of each of the terminal 110 and the bus bar 200 is illustrated as an example. However, the coupling portion 300 may be prepared using any of the structures described in FIGS. 7A to 8D or a combination thereof.

In an embodiment, for example, the coupling portion 300 includes a first coupling portion 301 and a second coupling portion 302. The first coupling portion 301 is formed on a side of the bus bar 200. The second coupling portion 302 is formed on a side of the terminal 110.

In an embodiment, an uneven structure is formed on a surface of at least one of the first coupling portion 301 and the second coupling portion 302. In an embodiment, the uneven structure may be formed only on the surface of the first coupling portion 301, and may not be formed on the surface of the second coupling portion 302. In another embodiment, the uneven structure may be formed only on the surface of the second coupling portion 302, and may not be formed on the surface of the first coupling portion 301. In another embodiment, the uneven structure may be formed on both the surface of the first coupling portion 301 and the surface of the second coupling portion 302.

The uneven structure includes, for example, a structure in which unevenness is formed on the surface. The uneven structure includes, for example, a structure having a roughly formed surface. The uneven structure includes, for example, a structure in which concave portions and/or convex portions are formed. The uneven structure includes, for example, any shape that is not a smooth plane. In other words, the uneven structure includes any type of structure that can have a larger surface area compared to a flat surface.

As described above, in the battery module 1000 according to an embodiment of the present invention, the coupling portion 300 is provided on each of the bus bar 200 and the terminal 110. In an embodiment, the coupling portion 300 has an uneven structure. Accordingly, the battery module 1000 provides the coupling portion 300 with a strong coupling force.

In an embodiment, such an uneven structure can also be applied to the coupling portion 300 described in FIGS. 7A to 8D. In this case, the surface of the coupling portion 300, on which the uneven structure is formed, may be coupled to the bus bar 200 or the terminal 110. Accordingly, the battery module 1000 according to an embodiment of the present invention can provide the coupling portion 300 with an improved surface area that provides a magnetic force. In addition, the battery module 1000 provides the coupling portion 300 with a strong coupling force.

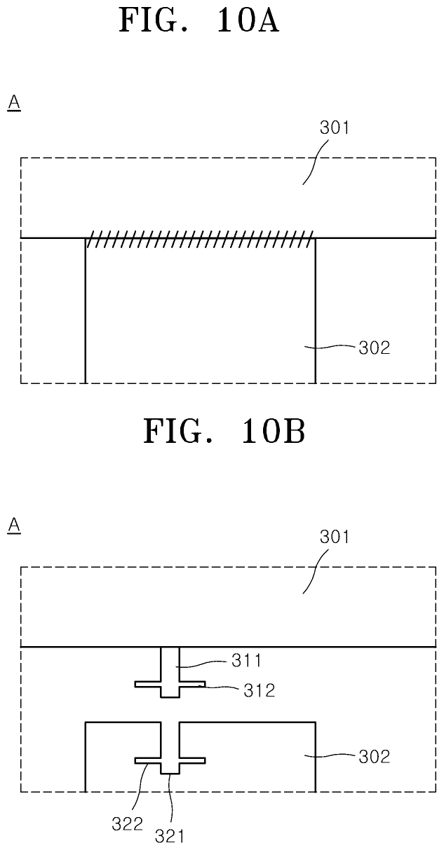

FIGS. 10A and 10B are cross-sectional views schematically illustrating an example of a region “A” of FIG. 9.

In FIGS. 10A and 10B, the region “A” of FIG. 9 is enlarged to provide a more detailed illustration of the uneven structure described in FIG. 9.

FIG. 10A illustrates an example in which the uneven structure is formed on the surface of the coupling portion 300. The surface of the coupling portion 300 on which the uneven structure is formed may include, for example, a roughly formed surface.

In an embodiment, for example, the uneven structure is formed on a surface of at least one of the first coupling portion 301 and the second coupling portion 302. For example, the surface of the first coupling portion 301 is formed to be rough. In an embodiment, the surface of the first coupling portion 301 is a surface formed on a side of the first coupling portion 301, which faces the second coupling portion 302, among surfaces of the first coupling portion 301. For example, the surface of the second coupling portion 302 is formed to be rough. In an embodiment, the surface of the second coupling portion 302 is a surface formed on a side of the second coupling portion 302, which faces the first coupling portion 301, among surfaces of the second coupling portion 302. By roughly forming the surface of at least one of the first coupling portion 301 and the second coupling portion 302, a coupling force between the first coupling portion 301 and the second coupling portion 302 can be improved.

The expression “roughly formed surface” may be, for example, a surface on which regular and/or irregular protrusions are formed. In an embodiment, the protrusion may include shapes, such as a prism and a cylinder, which have a same size at upper and lower portions. In an embodiment, the protrusion may include shapes, such as a mushroom shape, a polygonal pyramid, and a cone, which have different sizes at upper and lower portions. In another embodiment, the protrusion may include a combination of these shapes.

In an embodiment, the expression “roughly formed surface” may be, for example, a surface formed with a roughness average (Ra) value greater than or equal to 0.001 um in the coupling portion 300. In an embodiment, the expression “roughly formed surface” may be, for example, a surface formed with an Ra value greater than or equal to 0.005 um in the coupling portion 300. In an embodiment, the expression “roughly formed surface” may be, for example, a surface formed with an Ra value greater than or equal to 0.010 um in the coupling portion 300. In an embodiment, the expression “roughly formed surface” may be, for example, a surface formed with an Ra value greater than or equal to 0.015 um in the coupling portion 300. In an embodiment, the expression “roughly formed surface” may be, for example, a surface formed with an Ra value greater than or equal to 0.020 um in the coupling portion 300. In an embodiment, the expression “roughly formed surface” may be, for example, a surface formed with an Ra value greater than or equal to 0.030 um in the coupling portion 300. In an embodiment, the expression “roughly formed surface” may be, for example, a surface formed with an Ra value greater than or equal to 0.040 um in the coupling portion 300. In an embodiment, the expression “roughly formed surface” may be, for example, a surface formed with an Ra value greater than or equal to 0.050 um in the coupling portion 300. In an embodiment, the expression “roughly formed surface” may be, for example, a surface formed with an Ra value greater than or equal to 0.060 um in the coupling portion 300. In an embodiment, the expression “roughly formed surface” may be, for example, a surface formed with an Ra value greater than or equal to 0.070 um in the coupling portion 300. In an embodiment, the expression “roughly formed surface” may be, for example, a surface formed with an Ra value greater than or equal to 0.080 um in the coupling portion 300. In an embodiment, the expression “roughly formed surface” may be, for example, a surface formed with an Ra value greater than or equal to 0.090 um in the coupling portion 300. In an embodiment, the expression “roughly formed surface” may be, for example, a surface formed with an Ra value greater than or equal to 0.100 um in the coupling portion 300. In an embodiment, the expression “roughly formed surface” may be, for example, a surface formed with an Ra value greater than or equal to 0.200 um in the coupling portion 300. In an embodiment, the expression “roughly formed surface” may be, for example, a surface formed with an Ra value greater than or equal to 0.300 um in the coupling portion 300. The surface cannot function as an uneven structure and cannot improve the magnetic force provided by the coupling portion 300 when the Ra value of the surface of the coupling portion 300 is less than 0.001 um.

FIG. 10B illustrates an example in which the uneven structure is formed in the surface of the coupling portion 300. The surface of the coupling portion 300 in which the uneven structure is formed may include, for example, a surface in which concave portions and/or convex portions are formed.

In an embodiment, for example, the first coupling portion 301 is formed on the bus bar 200. In an embodiment, for example, the first coupling portion 301 includes one or more protrusions. In an embodiment, for example, the protrusions include a first protrusion 311 formed to protrude in a first direction. In an embodiment, for example, the second coupling portion 302 is formed in the terminal 110. In an embodiment, for example, the second coupling portion 302 includes one or more concave portions. In an embodiment, for example, the concave portions include a first concave portion 321 formed to be concave in the first direction.

In an embodiment, for example, as the first coupling portion 301 approaches the second coupling portion 302, the first protrusion 311 may be inserted into the first concave portion 321. The first protrusion 311 and the first concave portion 321 may be formed to correspond to each other. Accordingly, the first coupling portion 301 and the second coupling portion 302 according to an embodiment of the present invention can improve the coupling force with respect to each other.

In an embodiment, for example, the first direction is a direction in which the first coupling portion 301 and the second coupling portion 302 approach each other. For example, the first direction is a direction perpendicular to the surface of each of the first coupling portion 301 and the second coupling portion 302. However, the first direction is not limited thereto.

In an embodiment, for example, the protrusions may further include a second protrusion 312 that protrudes from the first protrusion 311 in a second direction. In an embodiment, the second protrusion 312 may be embedded in the first protrusion 311, and the first protrusion 311 may be inserted into the first concave portion 321. The second protrusion 312 may protrude from the inside of the first protrusion 311 after the first protrusion 311 is inserted into the first concave portion 321. The second direction is different from the first direction. In an embodiment, for example, the second direction has an angle other than 180 degrees from the first direction. For example, the second direction may be perpendicular to the first direction. In addition, for example, the concave portions may further include a second concave portion 322 formed to be concave in the second direction from the first concave portion 321. In an embodiment, the second direction is different from the first direction. Accordingly, the first coupling portion 301 and the second coupling portion 302 according to an embodiment of the present invention can improve the coupling force with respect to each other.

FIGS. 10A and 10B illustrate an example in which the protrusions are formed on the first coupling portion 301 and the concave portions are formed in the second coupling portion 302; however, embodiments of the present invention are not limited thereto. For example, the concave portions may be formed in the first coupling portion 301 and the protrusions may be formed on the second coupling portion 302.

However, the examples described with reference to FIGS. 7A to 10B are some example embodiments of the present invention, and forms of the battery module 1000 according to the present invention are not limited to those described in FIGS. 7A to 10B.

For example, the battery module 1000 includes a first coupling portion and a second coupling portion. The first coupling portion is formed on a surface of the bus bar 200, and the second coupling portion is formed by being embedded in the terminal 110. In an embodiment, the first coupling portion is formed by being embedded in the bus bar 200, and the second coupling portion is formed on a surface of the terminal 110. Accordingly, the battery module 1000 according to an embodiment can reduce the size of the battery module 1000 while enhancing the coupling force of the coupling portion 300.

In an embodiment, for example, the battery module 1000 includes a first coupling portion and a second coupling portion. The first coupling portion is formed to be internally and externally mounted on the bus bar 200 and has an area corresponding to an entire surface of the bus bar 200. The second coupling portion is formed to be internally and externally mounted on the terminal 110 and has an area corresponding to a portion or the entire surface of the terminal 110. Accordingly, the battery module 1000 according to an embodiment can reduce material costs while enhancing the coupling force.

In an embodiment, for example, the battery module 1000 includes a first coupling portion formed on the bus bar 200. For example, the first coupling portion may be formed with roughness on a surface thereof, as described with respect to FIGS. 10A and 10B. Accordingly, the battery module 1000 according to an embodiment may increase a surface area to enhance the coupling force.

In an embodiment, for example, the battery module 1000 includes a second coupling portion formed on the terminal 110. For example, the second coupling portion is formed with roughness on the surface thereof as described in FIGS. 10A and 10B. Accordingly, the battery module 1000 according to an embodiment may increase a surface area to enhance the coupling force.

As described above, the battery module 1000 may be formed by a combination of all or some of the embodiments described in FIGS. 7A to 10B.

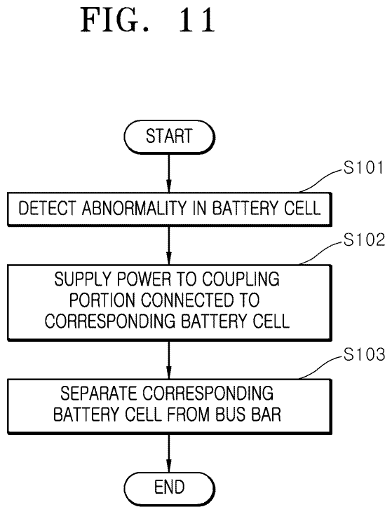

FIG. 11 is a flowchart describing an example of a method of driving the battery module according to an embodiment of the present invention.

The battery module 1000 according to an embodiment of the present invention may further include a power supply and/or a sensor.

In an embodiment, the sensor may detect an abnormality in at least one of the plurality of battery cells 100. The sensor may include, for example, a temperature sensor, an infrared sensor, a volume sensor, a chemical sensor, or the like. The sensor detects whether each of the plurality of battery cells 100 has at least one abnormality, or problem, among deterioration, swelling, temperature rise, heat generation, thermal runaway, gas leakage, and electrolyte leakage, for example.

The power supply is electrically connected to the coupling portion 300. The power supply supplies power to the coupling portion 300 connected to the battery cell 100 in which the abnormality is detected. In an embodiment, for example, the power supply allows current to flow to the coupling portion 300 itself. In another embodiment, for example, the power supply allows current to flow to a coil surrounding the corresponding coupling portion 300. Through this, the power supply may cancel out a magnetic force generated by the coupling portion 300. For example, the power supply may form a new induced magnetic force around the coupling portion 300. For example, the induced magnetic force may have a same or similar magnitude as the magnetic force generated by the coupling portion 300, and directions of the forces may be opposite to each other. Such an induced magnetic force may cancel out the magnetic force generated by the coupling portion 300. Through this, the power supply can weaken or eliminate the coupling force of the coupling portion 300.

The battery module 1000 may be driven, for example, as shown in FIG. 11 through the components described with respect to FIGS. 1 to 10.

In an embodiment, the battery module 1000 detects an abnormality in the battery cell 100 through the sensor (S101). In an embodiment, the battery module 1000 supplies power to the coupling portion 300 connected to the corresponding battery cell 100 through the power supply (S102). However, in an embodiment, the battery module 1000 may supply power to the coupling portion 300 through the power supply even if operation S101 is omitted. The battery module 1000 may separate the corresponding battery cell 100 from the bus bar 200. For example, the battery module 1000 can separate the battery cell 100 and the bus bar 200 from each other by canceling out the magnetic force generated by the coupling portion 300. However, in an embodiment, the battery module 1000 can separate the battery cell 100 from the bus bar 200 even if at least one of operations S101 or S102 is omitted.

Accordingly, the battery module 1000 according to an embodiment of the present invention may automatically detect a battery cell 100, in which an abnormality occurs, in the battery module 1000. In addition, the battery module 1000 may automatically separate the battery cell 100 in which an abnormality occurs.

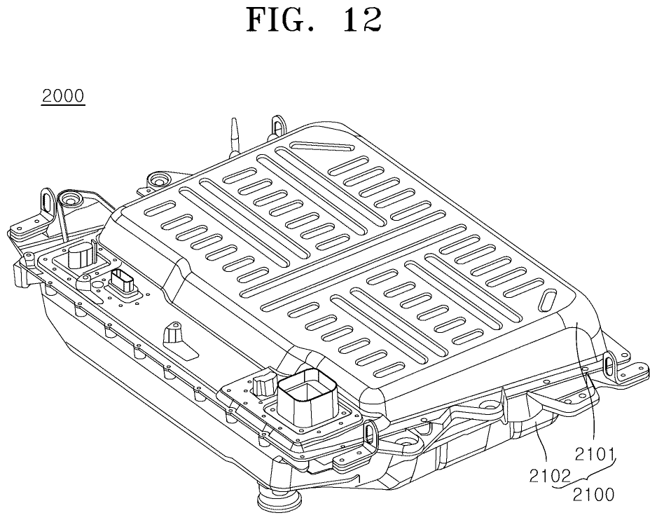

FIG. 12 is a view illustrating a battery pack according to an embodiment of the present invention.

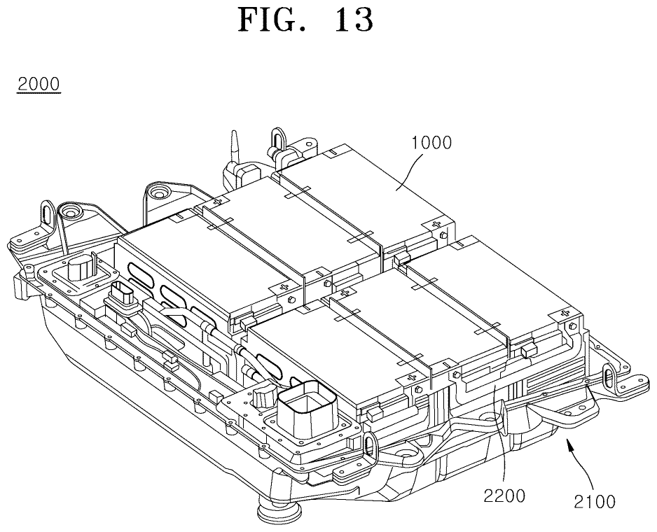

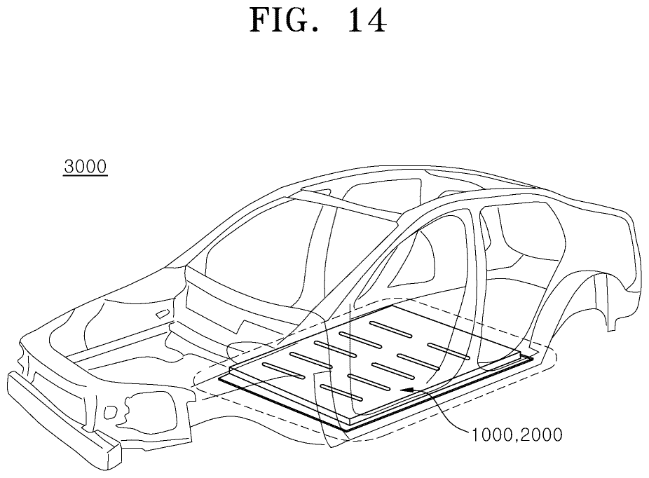

FIG. 13 is a view illustrating the battery pack according to an embodiment of the present invention.

A battery pack 2000 according to an embodiment of the present invention includes an assembly in which individual batteries are electrically connected, and a pack case that accommodates the assembly. In the drawings, for convenience of description, parts such as bus bars, cooling units, and external terminals for electrical connection of batteries are omitted.

The battery pack 2000 may include a plurality of battery modules 1000, such as the battery module 1000 described in FIGS. 5 to 11, and a pack case 2100 for accommodating the battery modules 1000. For example, the pack case 2100 may include first and second pack cases 2101 and 2102, which are coupled in a facing direction, with the plurality of battery modules 1000 interposed therebetween. The plurality of battery modules 1000 may be electrically connected to each other using a bus bar 2200, and a plurality of battery modules 1000 may be electrically connected to each other in a series/parallel configuration or a mixed series-parallel configuration to obtain a required electrical output.

FIG. 14 is a view illustrating a vehicle body and body parts according to an embodiment of the present invention.

The battery pack 2000 according to an embodiment of the present invention described in FIGS. 12 and 13 may be mounted on a vehicle 3000. The vehicle 3000 may be, for example, an electric vehicle, a hybrid vehicle, or a plug-in hybrid vehicle. The vehicle may include a four-wheeled vehicle or a two-wheeled vehicle, for example.

As shown in FIG. 14, the vehicle 3000 according to an embodiment of the present invention includes a battery module 1000 according to an embodiment of the present invention and/or a battery pack 2000 including the battery module 1000. The vehicle 3000 operates by receiving power from the battery module 1000 according to an embodiment of the present invention and/or the battery pack 2000 including the battery module 1000.

According to one or more embodiments of the present invention, a battery cell can be separated from a bus bar without damaging the battery cell.

According to one or more embodiments the present invention, a battery cell can be easily connected to a bus bar.

According to one or more embodiments the present invention, a proportion of discarded battery modules and/or battery packs can be reduced.

According to one or more embodiments the present invention, a recycling rate of various components included in a battery module and/or a battery pack can be increased.

According to one or more embodiments the present invention, an environmentally-friendly battery module and/or battery pack is provided.

However, it will be appreciated by persons skilled in the art that aspects and effects that can be achieved through the present invention are not limited to those described herein and other aspects, effects, and advantages of the present invention will be understood from the detailed description.

Although the present invention has been described with reference to some example embodiments and drawings, the present invention is not limited thereto and may be variously implemented by those of ordinary skill in the art to which the present invention pertains within the technical idea of the present invention and equivalents as set forth in the claims.

What is claimed is:

1. A battery module comprising:
a plurality of battery cells each comprising a terminal on at least one side;
a bus bar configured to electrically connect at least some of the plurality of battery cells; and
a coupling portion configured to couple the terminal and the bus bar through a magnetic force.

2. The battery module as claimed in claim 1, wherein the coupling portion is embedded in at least one of the terminal or the bus bar.

3. The battery module as claimed in claim 1, wherein the coupling portion is on a surface of at least one of the terminal or the bus bar.

4. The battery module as claimed in claim 1, wherein the coupling portion has an area corresponding to an entire surface of at least one of the terminal or the bus bar.

5. The battery module as claimed in claim 1, wherein the coupling portion has an area corresponding to a portion of a surface of at least one of the terminal or the bus bar.

6. The battery module as claimed in claim 1, wherein the coupling portion is configured to generate a tensile force greater than or equal to 300 N and less than or equal to 2500 N.

7. The battery module as claimed in claim 1, wherein the coupling portion comprises:
a first coupling portion on a side of the bus bar;
a second coupling portion on a side of the terminal; and
an uneven structure on a surface of at least one of the first coupling portion or the second coupling portion.

8. The battery module as claimed in claim 1, wherein the coupling portion comprises:
a first coupling portion on the bus bar and comprising one or more protrusions; and
a second coupling portion on the terminal and comprising one or more concave portions in which the one or more protrusions are received.

9. The battery module as claimed in claim 8, wherein
the one or more protrusions comprise a first protrusion protruding in a first direction, and a second protrusion protruding from the first protrusion in a second direction different from the first direction, and
the one or more concave portions comprise a first concave portion that is concave in the first direction, and a second concave portion that is concave in the second direction from the first concave portion.

10. The battery module as claimed in claim 1, wherein the coupling portion comprises at least one selected from the group consisting of a neodymium iron boron (NdFeB) magnet, a samarium cobalt (SmCo) magnet, a ferrite magnet, and a combination thereof.

11. The battery module as claimed in claim 1, further comprising a power supply configured to supply power to cancel out a magnetic force formed by the coupling portion.

12. The battery module as claimed in claim 11, further comprising a sensor configured to detect an abnormality in at least one of the plurality of battery cells,
wherein the power supply is configured to supply power to the coupling portion connected to the battery cell in which the abnormality is detected.

13. A battery pack comprising:
a plurality of battery modules; and
a pack case accommodating the plurality of battery modules,
wherein each of the battery modules comprises a plurality of battery cells each comprising a terminal on at least one side;
a bus bar configured to electrically connect at least some of the plurality of battery cells; and
a coupling portion configured to couple the terminal and the bus bar through a magnetic force.
